(19) United States
(12) Patent Application Publication
(10) Pub. No.: US 2019/0251250 A1
(43) Pub. Date: Aug. 15, 2019

(54) PREVENTION OF SHARING SENSITIVE CONTENT WHEN SIGNING UP WITH A SERVICE PROVIDER

(71) Applicant: CA, Inc., New York, NY (US)

(72) Inventors: Vikrant Nandakumar, Bangalore (IN); Lyju Vadassery, Mumbai (IN); Vijay Kulkarni, Bangalore (IN); Madhusudhan Ganda, Kadapa (IN)

(21) Appl. No.: 15/893,372

(22) Filed: Feb. 9, 2018

(51) Int. Cl. G06F 21/46; H04L 29/06; G06F 21/62

(52) U.S. Cl. CPC G06F 21/46; G06F 21/6245; H04L 63/083

(57) ABSTRACT

An application executing on a computer system may detect an account sign-up page for a new online account. The application may further capture account credentials entered by a user for the new online account. The application may attempt to login to one or more other online accounts using information based on the account credentials entered for the new online account. In response to logging in to at least one of the other online accounts using the information based on the account credentials, the application may request a change in the account credentials before the account credentials are submitted for the new online account.

### BACKGROUND

### Technical Field

Embodiments described herein are related to the field of data security, and more particularly to establishing secure passcodes.

### Description of the Related Art

Using computer systems, such as, for example, personal computers (PCs), laptops, smart phones, tablets, and other mobile and/or wearable devices, users may access a variety of data servers, cloud storage servers, financial institutions, online retailers, social media sites, and other networked computer services which may store sensitive information. These networked computer services may require the user to establish account credentials that include information such as user identifications (UIDs) and passcodes in order to access the sensitive information. A common practice when establishing account credentials is for a user to use an email address for the UID and then reuse a passcode that the user has used for access to other online services or web sites. While most online services may take suitable measures to protect the user's account credentials, a data breach at a particular service may open access to the user's account credentials to hackers and identity thieves. Account credentials used with more than one online service may open the user to theft at not only the service that suffered the data breach, but also to any other online service that utilizes the same credentials.

### SUMMARY OF THE EMBODIMENTS

Various embodiments of a sensor network are disclosed. Broadly speaking, a method is contemplated in which an application, executing on a computer system, may detect an account sign-up page for a new online account, and capture account credentials entered by a user for the new online account. The application may attempt to login to one or more other online accounts using information based on the account credentials entered for the new online account. In response to logging in to at least one of the other online accounts using the information based on the account credentials, the application may request a change in the account credentials before the account credentials are submitted for the new online account.

In a further embodiment, the one or more other online accounts are stored in a list of accounts of the user. The application may store the new online account in the list of accounts of the user, and attempt to login into the new online account upon detecting an account sign-up page for a subsequent additional online account to determine whether proposed account credentials for the additional online account match account credentials for the new online account.

In another embodiment, in response to the requested change in account credentials the application may receive different account credentials from the user, and use the different account credentials to attempt to login to the other online accounts. The application may permit submission of the different account credentials for the new online account based on the different account credentials not resulting in a valid login to the one or more other online accounts.

In one embodiment, in response to requesting the change in the account credentials, the application may receive an indication of an override from the user to accept the account credentials for the new online account. The application may determine whether to permit the override based on a classification of the particular other online accounts that matched the account credentials for the new online account.

### BRIEF DESCRIPTION OF THE DRAWINGS

The following detailed description makes reference to the accompanying drawings, which are now briefly described.

FIG. 1 illustrates an embodiment of an application executing on a computer system and exchanging information with an online server.

FIG. 2 shows a flow diagram for an embodiment of a method for validating a user's credentials.

FIG. 3 depicts an embodiment of a web browser executing on a computer system and exchanging information, using a browser extension, with an online server.

FIG. 4 illustrates an embodiment of an application executing on a computer system and exchanging information, using a passcode module, with an online server.

FIG. 5 shows a flow diagram for an embodiment of a method for validating a user's credentials using web browser and browser extension.

FIG. 6 depicts a block diagram for an embodiment of a computer system.

While the embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

As used throughout this disclosure, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION OF EMBODIMENTS

Data breaches occur far too regularly and have occurred to many well known and widely utilized online services. For example, major data breaches have occurred at Yahoo, Myspace, and LinkedIn, just to name a few, in which user account credentials were accessed by a hacker, resulting in affected users having to change account credentials for these web sites as well as any other online service which utilized the same credentials. One solution for users includes utilizing different account credentials for different services and websites. Users, however, tend to reuse account credentials to avoid having to remember various combinations, thereby creating a potential “domino effect” wherein a breach at one service creates a security risks at all other services in which the same credentials are used. In addition, deceptive websites may be used by hackers to trick a user into creating an account and thereby providing account credentials that the hackers may use to attempt to access other legitimate websites and online services. Deceptive websites may include, e.g., a website that is intentionally designed to look like another, legitimate website, or a website that is advertised as providing a particular service, but instead of providing the advertised service, simply collects account information.

Use of the same or similar account credentials across multiple online accounts may increase a risk of the credentials being discovered by a hacker. If a hacker manages to discover account credentials for a first online account, the hacker may attempt to use the same credentials for other online accounts. The chances of discovery, therefore, increase for every online account that the same credentials are used by a user. In addition to the risk of discovery, use of the same credentials puts more of the user's restricted information at risk if the credentials are discovered by a hacker.

Various embodiments of methods for improving the security of users' account credentials are described in this disclosure. The embodiments illustrated in the drawings and described below may provide techniques for reducing risks of a user's passcode being discovered by an unauthorized third-party, e.g., a hacker.

It is noted that, as used herein, “online” refers to a connected state of a server computer, computer system, mobile device, or other computing device, to a wide area network, such as, for example, the Internet. A computing device said to be “online” when it is capable of being accessed by, or accessing, other computing devices connected to the network. In reference to an account, “online” refers to an account that is hosted by an online server or other type of online computing device, and, accordingly, may be accessed via the wide area network.

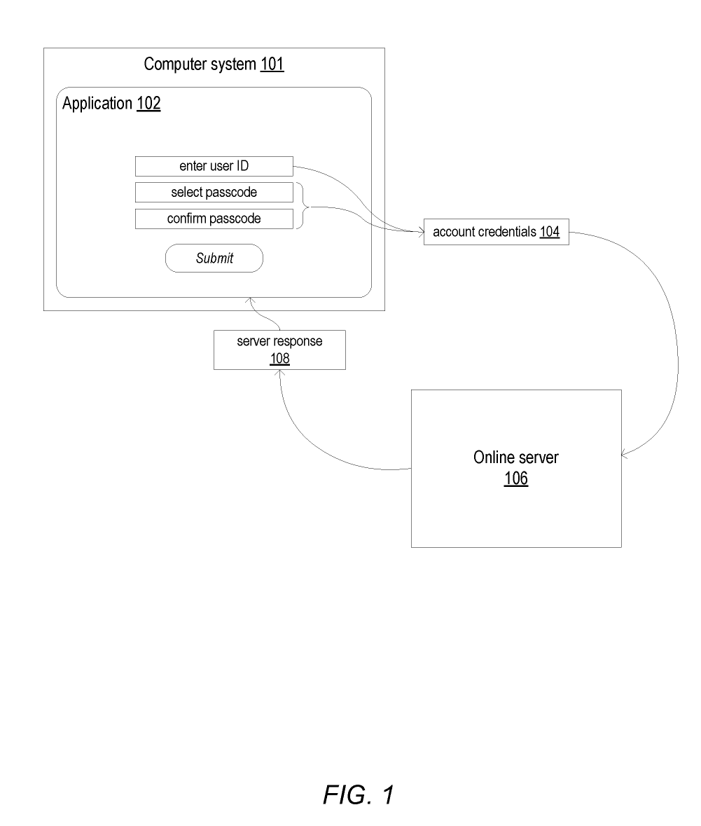

A representation of an embodiment of a computer system communicatively coupled to an online server is shown in FIG. 1. Computer system 101 is coupled to online server 106 via a multiuser computing network. In the illustrated embodiment, a user enters account credentials 104 into application 102, running on computer system 101. Online server 106 receives account credentials 104 from application 102 and sends server response 108 back to application 102.

Computer system 101, in the illustrated embodiment, corresponds to any type of computer system that is capable of accessing the Internet, including, but not limited to, desktop computers, smart phones, tablet computers, notebook computers, smart home devices, smart watches, and the like. Computer system 101 executes application 102, which corresponds to any type of application that provides a user access to information and/or services that are restricted to authorized users. Application 102 may, for example, correspond to a banking or other financial application, a cloud storage application, an online shopping application, a web browser, a web browser extension, and other such applications. To authorize a particular user, application 102 utilizes an interface displayed on computer system 101 to prompt a user to enter a user identification (UID) and passcode combination (this combination also referred to herein as “account credentials”).

As used herein, a “passcode” refers to any type of code used to identify a user and provide access to sensitive information. In various embodiments, a passcode may correspond to a personal identification number (PIN), password, pass phrase, answer to a security question, and the like.

In the illustrated embodiment, application 102 may prompt the user to create an account while in an account creation mode. Application 102 may enter the account creation mode upon an initial use of application 102, a first attempt to access restricted content, in response to the user selecting a new account option, or other similar actions by the user. As shown in FIG. 1, application 102 prompts the user to enter a UID, such as, e.g., an email address, and establish a corresponding passcode by entering the passcode twice, and then selecting a “submit” icon to submit the entered credentials. In response to the selection of the submit icon, application 102 verifies that both entries of the new passcode match and, if so, determines if account credentials 104 are used as credentials for another online account by attempting to login to one or more online accounts using account credentials 104. To attempt the login, application 102 sends account credentials 104, or login information based on account credentials 104, to online server 106. The one or more online accounts may correspond to any combination of online accounts, including, for example, email accounts, social media accounts, cloud storage accounts, online shopping accounts, financial institution accounts, and the like.

After validating the received credentials, online server 106 sends server response 108 to application 102. Server response 108 includes an indication if account credentials 104 are valid account credentials for a user account on online server 106. If account credentials 104 are valid account credentials, then application 102 alerts the user. In some embodiments, this alert may correspond to a warning message displayed on computer system 101 stating that the entered credentials are valid for an account on another online server (the identity of the third-party may not be displayed in the alert), and provide the user an opportunity to enter different credentials, e.g., enter a different passcode and/or use a different UID. In other embodiments, this alert may include a statement that account credentials 104 have been rejected and application 102 may prompt the user to enter new credentials. If server response 108 indicates that the entered credentials are not valid for online server 106, then application 102 may accept account credentials 104 as valid credentials for accessing content using application 102.

In the illustrated embodiment, application 102 includes computer code that is executable on one or more processor circuits. Thus, various operations described herein may be performed by executing program instructions stored on a non-transitory computer-readable medium and executed by one or more processor circuits (not illustrated). The program instructions may be stored on a non-volatile medium such as flash memory, or may be stored in any other volatile or non-volatile memory medium or device as is well known, such as a ROM or RAM, or provided on any media capable of sharing program code, such as a compact disk (CD) medium, digital versatile disk (DVD) medium, a floppy disk, a flash-based storage, and the like. Additionally, the entire program code, or portions thereof, may be transmitted and downloaded from a software source such as, e.g., via the Internet, or a file transfer protocol (FTP) server, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a mobile computing system such as, for example, in C, C++, HTML, Java, JavaScript, or other such programming languages, including proprietary languages.

It is noted that FIG. 1 is merely an example for demonstrating disclosed concepts. Only components necessary to illustrate the disclosed concepts are shown in FIG. 1. Additional and/or different components may be included in other embodiments. For example, application processors and cellular radios may be included in a smart phone embodiment. It is further noted that, in some embodiments, the concepts presented herein may be combined with other known forms of validating account credentials, such as determining, for example, a length of a new passcode, a particular mix of characters used in the new passcode, whether the passcode has been previously used, and other similar known forms.

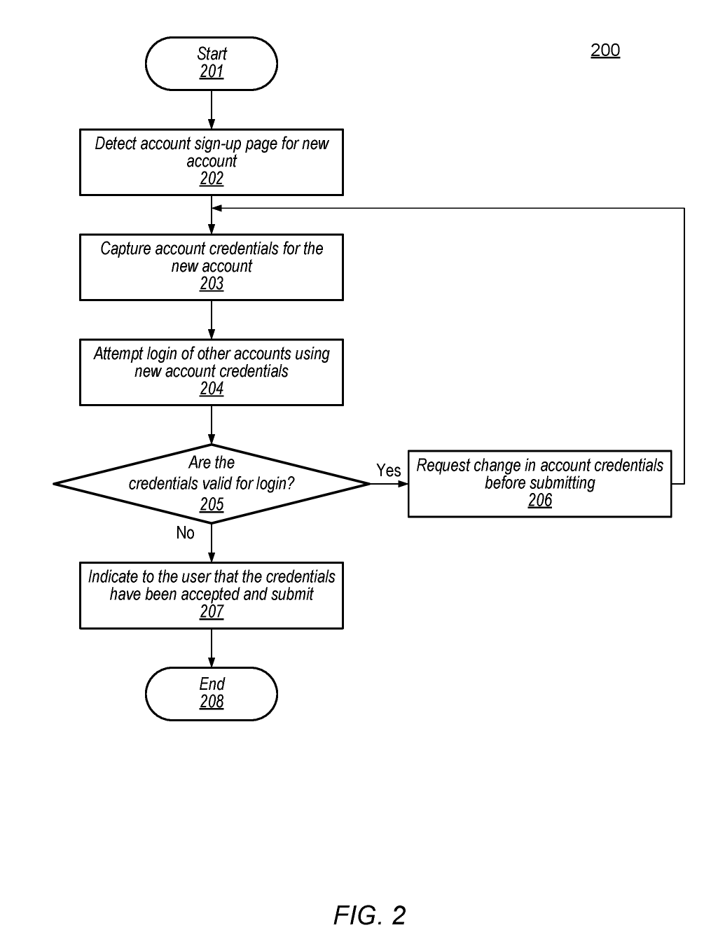

Turning to FIG. 2, a flow diagram for an embodiment of a method for validating account credentials submitted by a user is illustrated. Method 200 may be applied to a computer system such as, for example, computer system 101 in FIG. 1, using application 102. Referring collectively to FIG. 1 and the flow diagram in FIG. 2, the method begins in block 201.

An application executing on a computer system detects an account sign-up page for a new account (block 202). In the illustrated embodiment, application 102, executing on computer system 101, may detect the account sign-up page by determining that new account credentials are to be generated. In response to detecting that new account credentials are to be generated, application 102 activates an account generation mode within application 102 that causes computer system 101 to display an account sign-up page. Application 102 may determine that new account credentials are to be generated due to various actions, such as, for example, in response to an initial use of application 102, a first attempt to access restricted content using application 102, in response to the user selecting a new account option, in response to the user entering invalid credentials a predetermined number of times, and the like. In some embodiments, application 102 may detect the account sign-up page by comparing information, such as a uniform resource locator (URL) associated with the account sign-up page, to a stored list of URLs. For example, one or more applications on computer system 101 may store URLs for known online account sign-up pages. If application 102 accesses a URL corresponding to a known account sign-up page, then application 102 may activate the account generation mode, in addition to causing computer system 101 to display the account sign-up page.

The application captures account credentials entered by a user for the new online account (block 203). In the illustrated embodiment, application 102 detects that the user has entered account credentials 104 into computer system 101. Account credentials 104 may include a UID and a passcode, and in some embodiments, additional information. Application 102 also, in some embodiments, may prevent account credentials 104 from being sent to the new online account until the entered credentials have been verified to be invalid on other online accounts. Application 102 may also, in some embodiments, generate one or more modified account credentials by making changes to the information in account credentials 104. For example, application 102 may add or change a character at an end of a passcode in account credentials 104, such as, e.g., adding a “1” to an end of the passcode or if the passcode ends in “33,” generating other passcodes ending in “30,” “31,” “32,” and “34.” In other words, application may attempt common variations of an entered passcode or UID such as a hacker may attempt.

The application attempts to login to one or more other online accounts using information based on the new account credentials (block 204). Application 102, in the illustrated embodiment, sends account credentials 104 to online server 106 as an attempt to login to the third-party's server. In some embodiments, application 102 may attempt to login to more than one third-party server. For example, application 102 may maintain a list of third-party servers from which one or more servers are selected. A server corresponding to the new online account may be added to the list if it is not already included. In some embodiments, application 102 may attempt to login into the new online account upon detecting an account sign-up page for a subsequent additional online account to determine whether or not proposed account credentials for the additional online account match account credentials for the new online account. In other embodiments, application 102 may contact a particular third-party server to retrieve a maintained list of servers from which to select one or more servers. For example, the particular third-party server may maintain an updated list of popular servers that utilize account credentials. In some embodiments, application 102 may select the one or more servers from both a locally maintained list as well as a third-party list.

Once the one or more servers have been selected, application 102 may attempt to login into each selected system using account credentials 104. In some embodiments, online server 106 may be selected based on account credentials 104. For example, if account credentials 104 include an email address, then application 102 may select as a third-party computer system an email server corresponding to an email domain of the email address. If account credentials 104 includes, e.g., “abc123@gmail.com,” then online server 106 may correspond to an email server for Gmail™. If, in block 203, application 102 generated modified account credentials, these modified account credentials may also be used in the login attempts, including using the included email address as a UID when logging into the email server, regardless if the email address is submitted as a UID or not in account credentials 104.

Further operation of method 200 may depend on the account credentials (block 205). In the illustrated embodiment, application 102 sends account credentials 104 (and, if applicable, modified account credentials) to one or more online servers in an attempt to login to respective online accounts on those servers. If at least one of the attempts succeeds, e.g., application 102 receives an indication that the attempt allows access to information restricted to the account owner, then the method moves to block 206 to request a change to account credentials 104. Otherwise, if all attempts to login to the other online accounts are unsuccessful, then method 200 moves to block 207 to submit account credentials 104 for the new online account.

If the application successfully logs into at least one of the other online accounts using the information based on the account credentials, then the application requests a change in the account credentials before the account credentials are submitted for the new online account (block 206). A successful login to at least one other online account may indicate that the account credentials that the user entered are not as secure as possible. Application 102, therefore, indicates to the user that account credentials 104 are not secure and requests the user to change at least a portion of the credentials, e.g., a passcode. Application 102 may inform the user that account credentials 104 are valid for another site without informing the user of the identity of the other online account or accounts for which the credentials were valid. In other embodiments, application 102 may simply indicate to the user that account credentials 104 are valid for another online account without explicitly identifying the other account. The method returns to block 203 to capture new account credentials and make new attempts to login to the other online servers using the new credentials.

If the application determines that the UID and the different passcode correspond to an invalid login for the other online server, then the application indicates to the user that the different passcode has been accepted (block 207). If application 102 fails to successfully login to another online account, then account credentials 104 may be approved by application 102 and a submit command may be issued to allow usage of account credentials 104 with the new online account. In some embodiments, a different application, executing on a server associated with the new online account, may perform additional checks before approving account credentials 104 for use with the new online account. For example, the different application may verify if a UID included in account credentials 104 is already in use with a different account on the server. The method ends in block 208.

It is noted that method 200 in FIG. 2 is an example embodiment. Variations of the example embodiment are contemplated and may include additional operations. In other embodiments, some operations may be performed in parallel or in a different sequence.

In the embodiment of method 200, application 102, executing on computer system 101, performs the attempted login to the one or more other online servers. It is further contemplated that in other embodiments, some or all of the actions described in blocks 202 through 207 may be performed by an online server for the new online account, rather than application 102. For example, a new account server may receive account credentials 104 from application 102, and then select one or more online servers 106 for the login attempts. If at least one of these login attempts is successful, then the new account server may send an indication to application 102, causing application 102 to request the user to change at least a part of account credentials 104. Otherwise, if the new account server fails to successfully login to another online account 106, then account credentials 104 may be approved by the new account serve for use with the new online account.

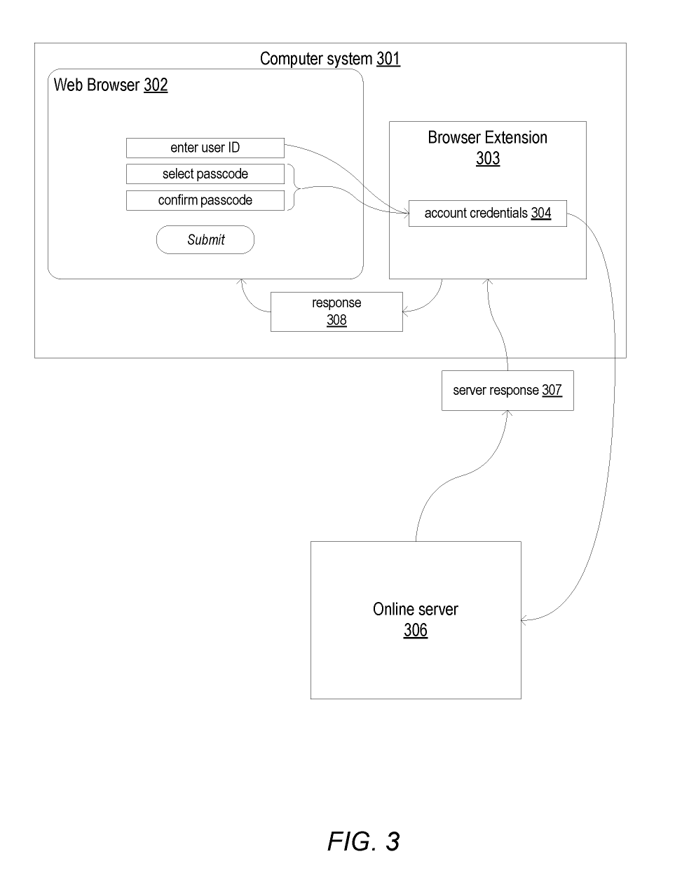

Moving to FIG. 3, another embodiment for creating a new online account is depicted. Many elements in FIG. 3 are similar to elements in FIG. 1 with similar names and numbers. Such elements operate as described above in regards to FIG. 1, except as disclosed below. FIG. 3 includes computer system 301 communicatively coupled to online server 306, via, e.g., an Internet connection. Computer system 301 executes web browser 302 and browser extension 303.

Similar to the system of FIG. 1, the system of FIG. 3 may be used to login to online accounts as well as to generate new online accounts. In the illustrated embodiment, computer system 301 executes web browser 302, allowing a user to access online server 306. Web browser 302 may correspond to any suitable software application for accessing online servers via URLs or other Internet addressing syntax. The user attempts to generate a new online account on online server 306 using web browser 302, and in response, online server 306 causes web browser 302 to display an account sign-up page that requests the user to enter credentials for accessing the new online account.

Browser extension 303 detects account credentials 304 that are entered by the user into the account sign-up page. In various embodiments, browser extension 303 may correspond to program instructions included within web browser 302, or program instructions included in a separate program that is activated by and executes in parallel to web browser 302. Browser extension 303 may add one or more functions to web browser 302. In some embodiments, web browser 302 and browser extension 303 may be created and/or owned by different parties. A user of computer system 301 may, in some embodiments, install browser extension 303 after installing web browser 302. In various embodiments, browser extension 303 may be referred to as a “browser plug-in,” a “browser add-on,” or other similar terms.

Browser extension 303, in the illustrated embodiment, determines that account credentials 304 are to be used for generating a new online account. In some embodiments, browser extension 303 may also determine if a passcode is being changed for an existing online account. Browser extension 303 may, in some embodiments, receive an indication from web browser 302 that a new account is being generated or that a passcode in account credentials 304 is being changed. For example, web browser 302 may execute an application programming interface (API) call to activate browser extension 303 when account credentials 304 are to be generated or changed. In other embodiments, browser extension 303 may monitor information sent and received by web browser 302 for inclusion of one or more keywords indicative of generation or change of account credentials 304. For example, browser extension 303 may monitor web browser 302 for a change from a URL using a Hypertext Transfer Protocol (HTTP) to a URL using an HTTP Secure (HTTPS). Browser extension 303 may use additional information to determine if a detected HTTPS URL is related to account credentials 304.

After detecting an account sign-up page (or an account credential change page) browser extension 303 may, in some embodiments, prevent web browser 302 from submitting account credentials 304 to online server 306 until browser extension 303 validates account credentials 304. To prevent web browser 302 from submitting account credentials 304, browser extension 303 may, in some embodiments, cause web browser 302 to enter an instruction loop or otherwise wait for a response from browser extension 303, thereby preventing web browser 302 from moving to instructions that submit the credentials. Once browser extension 303 has validated the current values for account credentials 304, then browser extension 303 sends response 308, allowing web browser 302 to move to the instructions that submit account credentials 304.

To validate the credentials, browser extension 303 sends account credentials 304 to one or more selected online servers, including online server 306, attempting to login to an account on each of these servers using information based on account credentials 304. Each of the selected online servers sends a respective server response 307 that includes an indication if the login attempt is successful. If any of these attempts is successful (e.g., server response 307 does not indicate invalid credentials), then browser extension 303 displays an indication for the user that the current values for account credentials 304 may pose a security risk, and requests that the user enter new values for account credentials 304.

In some embodiments, browser extension 303 may allow an option for the user to override the request for new credentials and instead keep the current values without changes. For example, browser extension 303 may display entry fields for changing account credentials 304 as well as an override option to keep the current values along with a displayed warning that use of the current values may be a security risk. In other embodiments, this override option may be ignored based on the identity of the new online account as well as the identity of any third-party accounts for which an attempted login is successful. For example, if a list of online servers is maintained (either on computer system 301 or a third-party server), then the list may include an indication or a classification for each online server if an option to keep the current account credentials 304 is allowable or not.

It is noted that FIG. 3 is merely one example used to demonstrate the disclosed concepts. Other embodiments may differ in one or more characteristics. For example, although the browser extension is illustrated as separate from the web browser, in some embodiments, the extension may be included as part of the web browser.

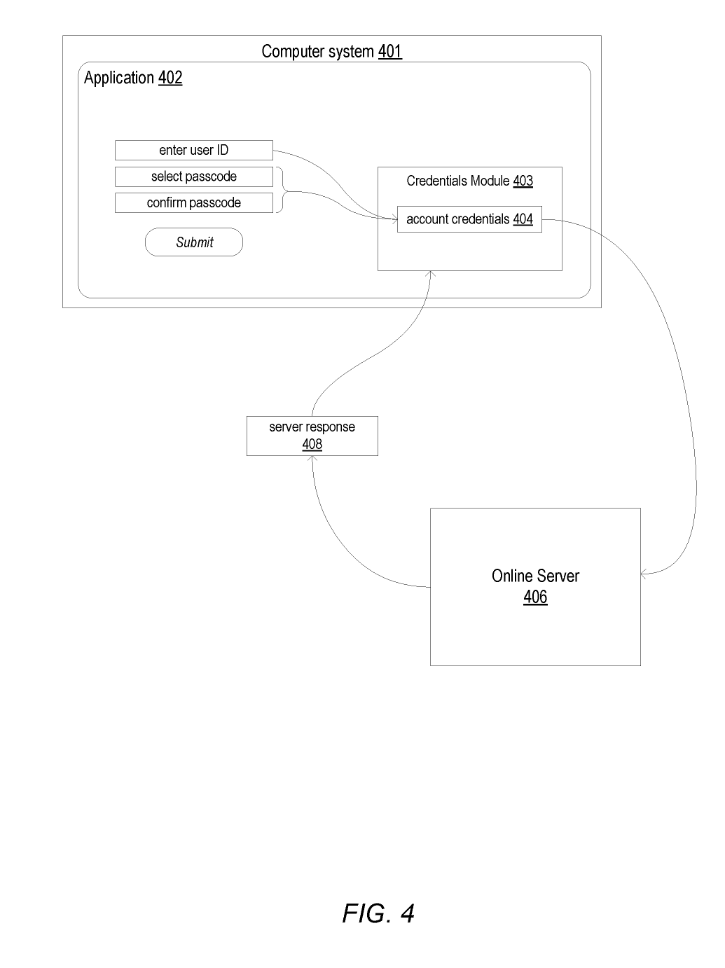

FIG. 4, similar to FIG. 3, illustrates another embodiment for creating a new online account. Many elements in FIG. 4 are similar to elements in FIGS. 1 and 3 with similar names and numbers. These similar elements may behave as described above in regards to FIGS. 1 and 3, except as disclosed below. The embodiment of FIG. 4 includes computer system 401 communicatively coupled to online server 406, via, e.g., an Internet connection. Computer system 401 executes application 402 and credentials module 403.

In the illustrated embodiment, application 402 corresponds to a software application that provides access to information restricted to a particular user of computer system 401. In some embodiments, application 402 may correspond to a financial/banking application for a particular financial institution that allows a user access to bank accounts, investment portfolios, and the like. In other embodiments, application 402 may correspond to a cloud storage/sharing application that allows a user or a group of users to store, retrieve, and modify various files on a remote server. In some embodiments, application 402 may correspond to an online shopping application that allows the user to utilize stored payment methods and other personal information such as a shipping address, such that the user may make purchases without re-entering payment and shipping information. Application 402 includes an account sign-up page that the user may use to create account credentials 404 for a new online account associated with the application. In some embodiments, application 402 may also include an account modify or edit page that allows the user to change various account including account credentials.

Credentials module 403, in the illustrated embodiment, corresponds to a software program module that may be included with application 402 when application 402 is installed on computer system 401. Credentials module 403 may, in various embodiments, be incorporated as a part of the source code of application 402 or may be maintained as a separate program that is activated by application 402, using an API call for example. In some embodiments, credentials module 403 may be created and/or owned by a different party that the party that creates or owns application 402.

In the illustrated embodiment, credentials module 403 may perform similar functions as browser extension 303 in FIG. 3. Credentials module 403 detects if application 402 displays a new account login page or an account credentials edit page. To detect the display of the new account login page, credentials module 403 may receive an indication from application 402. For example, the indication may correspond to an API call issued by application 402. In some embodiments, application 402, after receiving account credentials 404 from the user, sends these credentials to credentials module 403 for validation. Application 402 may be prevented from submitting account credentials 404 to the new online account until credentials module 403 approves the credentials.

Credentials module 403, in the illustrated embodiment, validates account credentials 404 in a similar manner as described above for browser extension 303 in FIG. 3, by attempting to login to one or more online servers 406 using information based on account credentials 404. If credentials module 403 receives at least one server response 408 that indicates that account credentials 404 is a valid login for the corresponding server, then credentials module 403 indicates to the user that the chosen account credentials may be a security risk and requests the user enter new values for account credentials 404. As described above, credentials module 403 may include an override option to use the current values despite the security risk.

After receiving new values for account credentials 404, credentials module 403 repeats the validation process. Once current values for account credentials 404 are determined to be invalid for the attempted online servers, credentials module 403 allows application 402 to submit the current values to the new online account.

It is noted that method 400 in FIG. 4 is an example embodiment. Variations of the example embodiment are contemplated and may include additional elements. For example, although a direct link is shown between the computer system and the online server, various other elements, such as, e.g., routers, switches, hubs and other networking equipment may be included between the computer system and the server.

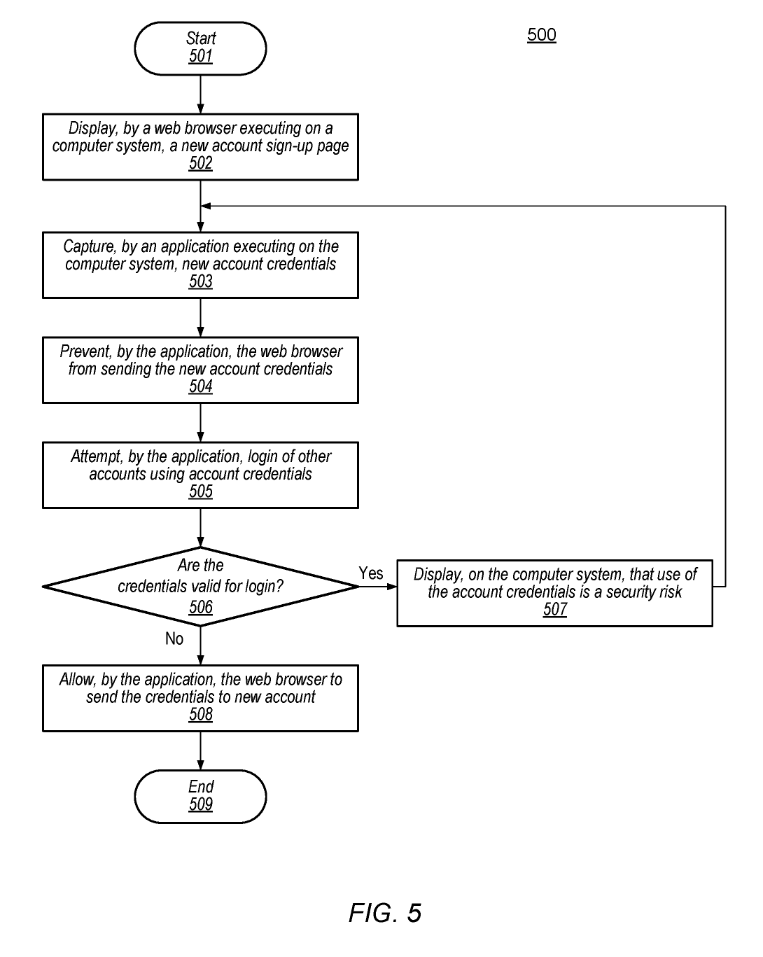

Moving now to FIG. 5, a flow diagram for an embodiment of a method for generating new account credentials using a web browser is shown. Method 500 may be applied to a computer system executing a web browser application, such as, for example, computer system 301 in FIG. 3. In other embodiments, method 500 may be applied to computer systems executing other applications, such as, e.g., computer system 401 in FIG. 4. Referring collectively to FIG. 3 and the flow diagram in FIG. 5, the method begins in block 501.

A web browser executing on a computer system displays a new account sign-up page (block 502). In the illustrated embodiment, a user of computer system 301 uses web browser 302 to create a new online account. A server associated with the new online account causes web browser 302 to display a new account sign-up page. The new account sign-up page may include fields for entering account credentials 304, including, for example, a UID, a passcode, and a passcode confirmation. The new account sign-up page may include a “submit” icon for sending the entered credentials to the associated server to create the account.

An application executing on the computer system captures new account credentials (block 503). Browser extension 303, in the illustrated example, detects the entry of account credentials 304 and retrieves a copy of the values. Browser extension 303, in different embodiments, may detect the entry of account credentials 304 either before or after the submit icon is selected by the user. In some embodiments, web browser 302 may send an indication to browser extension 303 that a new online account is being created, while, in other embodiments, browser extension 303 may monitor communication between web browser 302 and various servers for occurrences of one or more keywords that indicate that the user is creating new account credentials.

The application prevents the web browser from sending the new account credentials (block 504). In the illustrated example, browser extension 303 prevents web browser 302 from submitting account credentials 304 to the associated server until browser extension 303 has approved the values of account credentials 304. Browser extension 303 may utilize any suitable method for preventing web browser 302 from submitting account credentials 304. For example, if browser extension 303 detects the entry of account credentials 304 before the submit icon is selected, then browser extension 303 may prevent the user from selecting the submit icon by, for example, obscuring the submit icon with a pop-up window, or, if supported by web browser 302, requesting web browser 302 to ignore user input on the account sign-up page until browser extension 303 approves values of account credentials 304.

If browser extension 303 otherwise detects entry of account credentials 304 after the submit icon has been selected by the user, then browser extension 303 may prevent web browser from sending account credentials 304 by other suitable methods. For example, browser extension 303 may cause web browser 302 to enter a program loop before the credentials are sent. In other embodiments, web browser 302 may send, by default, account credentials 304 to browser extension 303, and let browser extension 303 forward the credentials to the associated server. In such an embodiment, browser extension 303 holds account credentials 304 until the approval process has completed.

The application attempts to login to other accounts using information based on account credentials (block 505). Browser extension 303, in the illustrated embodiment, sends account credentials 304 to online server 306 as an attempt to login to accounts on one or more online servers. For example, browser extension 303 may maintain a list of third-party servers from which one or more servers are selected. Browser extension 303 may then attempt to login into each selected server using information based on account credentials 304. As described above in regards to block 204 of FIG. 2, one of the one or more online servers may be selected based on account credentials 304. In addition, browser extension 303 may generate more one or more sets of modified account credentials based on account credentials 304, as described above in regards to FIG. 2.

Further operations of method 500 may depend on the account credentials (block 506). Browser extension 303 determines if information based on account credentials 304 is valid for login to an account on online server 306. Browser extension 303, in the illustrated embodiment, determines if any attempt to login to the one or more online accounts is successful. For example, server response 307 may include an indication of a successful login. If at least one attempt to login to another online account is successful, then method 500 moves to block 507 to display that the current account credentials may pose a security risk. Otherwise, the method moves to block 508 to allow the web browser to submit the new account credentials.

If at least one login attempt is successful, then the application causes the computer system to display a warning that use of the account credentials is a security risk (block 507). In the current embodiment, browser extension 303 causes computer system 301 to display, in a pop-up window for example, a warning to the user that the current values for account credentials 304 may pose a security risk. In some embodiments, the warning may include an indication that account credentials are used with another online account, while, in other embodiments, the warning may simply indicate that account credentials 304 are at risk for discovery. In various embodiments, browser extension 303 may cause web browser 302 to reset the account sign-up page, or may include fields in the pop-up window to enter new values for account credentials 304. The method returns to block 503 to capture new values for account credentials 304.

It is noted that, in some embodiments, browser extension 303 may include an option, as described above, to allow the user to submit the current values of account credentials 304 after acknowledging the security risk. In such embodiments, if this override option is selected by the user, then the method may proceed to block 508 to allow submission of the current values of account credentials 304. Browser extension 303 may indicate to web browser 302 that the current values are approved.

If none of the login attempts are successful, then the application allows the web browser to send the credentials to the new account (block 508). If browser extension 303 determines that all attempts to access other online accounts with information based on account credentials 304 have failed, web browser 302 may submit account credentials to the server associated with the new online account. For example, browser extension 303 may send response 308 to web browser 302. Response 308 may include an indication that account credentials 304 have been approved by browser extension 303. If browser extension 303 prevented web browser 302 from submitting the credentials by causing web browser 302 to enter a program loop, then response 308 may cause web browser 302 to exit the program loop and proceed to instructions that result in account credentials 304 being submitted. In other embodiments, if browser extension 303 prevented the user from selecting the submit icon, then browser extension 303 removes such restrictions and allows the user to select the submit icon. The method ends in block 509.

It is also noted that the embodiment of FIG. 5 is one example. The operations described above are directed towards a computer system executing a web browser. In other embodiments, however, method 500 may be applied to computer systems executing other types of applications, such as, for example, the embodiment of FIG. 4. In some embodiments, operations may be performed in a different order and/or a different number of operations may be performed.

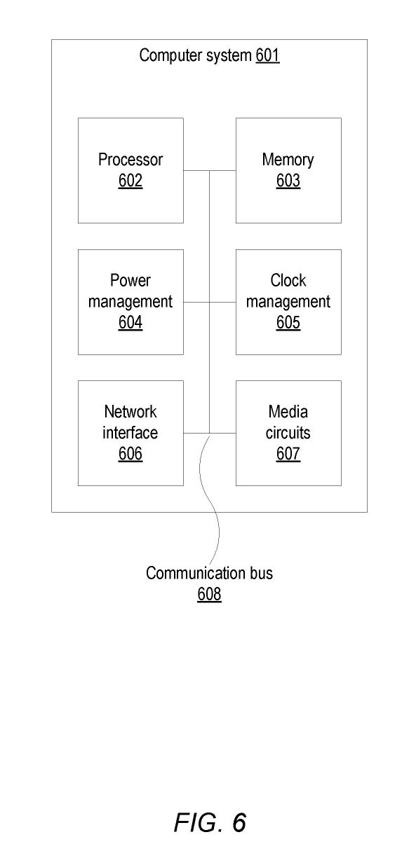

Turning to FIG. 6, a block diagram of an example computer system is illustrated. Computer system 601, in various embodiments, may correspond to any of the computer systems disclosed herein, such as, for example computer system 101 in FIG. 1. In the illustrated embodiment, computer system 601 includes processor circuit 602, memory circuit 603, power management unit 604, clock management unit 605, network interface 606, and media circuits 607, each of which may be configured to send requests and data (collectively transactions) to the other circuit blocks using communication bus 608. In various embodiments, computer system 601 may correspond to a desktop computer, a server, or a mobile device such as, e.g., a tablet computer, smart phone, a laptop computer, or a wearable computer system.

Processor circuit 602 may, in various embodiments, be representative of a general-purpose processor that performs computational operations. For example, processor circuit 602 may be a central processing unit (CPU) such as a microprocessor, a microcontroller, an application-specific integrated circuit (ASIC), or a field-programmable gate array (FPGA). Processor circuit may, in some embodiments, be configured to execute instructions from one or more instruction set architectures (ISAs).

Memory circuit 603, in some embodiments, may include volatile and/or non-volatile memory used to store and execute instructions and data for one or more application programs, such as, for example, applications 102, and 402, web browser 302, as well as browser extension 303 and credentials module 403, and other applications disclosed above. In various embodiments, memory circuit 603 may include any suitable type of memory such as, for example, a Dynamic Random Access Memory (DRAM), a Static Random Access Memory (SRAM), a Read-only Memory (ROM), Electrically Erasable Programmable Read-only Memory (EEPROM), flash memory, other non-volatile memory, or a combination thereof. It is noted that in the embodiment illustrated in FIG. 6, a single memory circuit is depicted. In other embodiments, any suitable number of memory circuits may be employed.

Power management unit 604 may be configured to generate a regulated voltage level in order to provide power to one or more of the circuit blocks included in computer system 601. In various embodiments, power management unit 604 may include one or more voltage regulator circuits configured to generate the regulated voltage level based on an external power supply (not shown). It is noted that although a single internal power supply is depicted in the embodiment of FIG. 6, in other embodiments any suitable number of internal power supplies may be employed.

Clock management unit 605 may include circuits used to generate, adjust, and distribute one or more clock signals to be used by the functional circuits included in computer system 601. In some embodiments, clock management unit 605 may include one or more oscillator circuits for generating a reference clock signal with a particular frequency using a clock crystal (not shown), as well as circuits for generating system clock signals with other frequencies from the reference frequency, circuits such as phase-locked loops (PLLs) and/or frequency-locked loops (FLLs).

Network interface 606, in the illustrated embodiment, includes circuits used to couple computer system 601 to other computing devices via one or more network protocols. For example, network interface 606 may include an Ethernet controller, a Wi-Fi radio, a Universal Serial Bus (USB) interface, a Bluetooth radio, or any combination thereof. Network interface 606, in the illustrated embodiment, couples computer system 601 to one or more online servers via a connection to the Internet.

In the illustrated embodiment, media circuits 607 include circuits used to provide feedback or information to a user of computer system 601. Media circuits 607 may include an audio processing circuit, one or more speakers, one or more microphones, a graphics processor, one or more cameras, image processing circuits, and the like. In the illustrated embodiment, media circuits 607 include circuits for displaying output from various applications on a display viewable by a user of computer system 601.

Computer system 601 is one example of a computer system that may be used in conjunction with the concepts disclosed herein. For clarity, only basic circuits associated with some computer systems are illustrated. In other embodiments, additional functional circuits, and/or additional occurrences of the illustrated functional circuits may be included.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
detecting, by an application executing on a computer system, an account sign-up page for a new online account;
capturing, by the application, account credentials entered by a user for the new online account;
attempting, by the application, to login to one or more other online accounts using information based on the account credentials entered for the new online account; and
in response to logging in to at least one of the other online accounts using the information based on the account credentials, requesting, by the application, a change in the account credentials before the account credentials are submitted for the new online account.

2. The method of claim 1, wherein the one or more other online accounts are stored in a list of accounts of the user, the method further comprising:
storing the new online account in the list of accounts of the user; and
attempting to login into the new online account upon detecting an account sign-up page for a subsequent additional online account to determine whether proposed account credentials for the subsequent additional online account match account credentials for the new online account.

3. The method of claim 1, further comprising, in response to the requested change in account credentials:
receiving, by the application, different account credentials from the user;
using, by the application, the different account credentials to attempt to login to the other online accounts; and
permitting submission of the different account credentials for the new online account based on the different account credentials not resulting in a valid login to the one or more other online accounts.

4. The method of claim 1, further comprising:
in response to requesting the change in the account credentials, receiving an indication of an override from the user to accept the account credentials for the new online account; and
determining whether to permit the override based on a classification of particular other online accounts that matched the account credentials for the new online account.

5. The method of claim 1, wherein the attempting includes:
determining that the account credentials include an email address; and
making a login attempt to an email server associated with the email address as one of the other online accounts, wherein the login attempt is based on using the email address as a user identification for the email server.

6. The method of claim 1, wherein the detecting the account sign-up page comprises comparing, by the application, a uniform resource locator (URL) associated with the account sign-up page to a list of URLs stored on the computer system.

7. The method of claim 1, wherein the attempting includes, for one or more of the other online accounts, attempting to login using the same account credentials entered by the user for the new online account, as well as using at least one variation of the account credentials.

8. The method of claim 1, wherein the application corresponds to a browser extension.

9. The method of claim 1, wherein the one or more other online accounts include online accounts that have been previously established by the user.

10. The method of claim 1, wherein the one or more other online accounts include one or more online accounts selected from a list of accounts that are maintained by a third-party service.

11. A non-transitory, computer-readable medium storing instructions that, when executed by a computer system, cause the computer system to perform operations comprising:
detecting, by an application executing on the computer system, an account sign-up page for a new online account;
capturing account credentials entered by a user for the new online account;
attempting to login to one or more other online accounts using information based on the account credentials entered for the new online account; and
in response to logging in to at least one of the other online accounts using the information based on the account credentials, requesting a change in the account credentials before the account credentials are submitted for the new online account.

12. The non-transitory, computer-readable medium of claim 11, wherein a different application generates the account sign-up page, and further comprising preventing, by the application, the account credentials from being submitted by the different application to the new online account.

13. The non-transitory, computer-readable medium of claim 12, wherein preventing the account credentials from being submitted by the different application comprises, preventing, by the application, a submit command to be received by the different application.

14. The non-transitory, computer-readable medium of claim 13, further comprising allowing, by the application, the different application to receive the submit command in response to a determination that all attempts to login to the other online accounts are unsuccessful.

15. The non-transitory, computer-readable medium of claim 12, wherein the different application corresponds to a web browser and the application corresponds to browser extension.

16. The non-transitory, computer-readable medium of claim 11, further comprising:
generating, by the application, one or more passcodes by modifying information in the account credentials; and
attempting to login to the one or more other online accounts using the one or more passcodes.

17. The non-transitory, computer-readable medium of claim 11, further comprising selecting at least one of the one or more other online accounts based on information included in the account credentials.

18. A mobile device, comprising:
a network interface configured to provide access to a plurality of online servers;
a processor configured to execute instructions that cause the mobile device to perform operations comprising:
detecting an account sign-up page for a new online server of the plurality of online servers;
capturing account credentials entered by a user for the new online server;
attempting to login to one or more other online servers of the plurality of online servers using information based on the account credentials entered for the new online server; and
in response to logging in to at least one of the other online servers using the information based on the account credentials, requesting a change in the account credentials before the account credentials are submitted for the new online server.

19. The mobile device of claim 18, wherein the instructions further cause the mobile device to perform operations comprising:
receiving changed account credentials from the user;
attempting to login to the one or more other online servers using information based on the changed account credentials; and
in response to a determination that all attempts to login to the other online servers are unsuccessful, submitting the account credentials to the new online server.

20. The mobile device of claim 18, wherein the instructions further cause the mobile device to perform operations comprising detecting the account sign-up page for the new online server by detecting a selection, by the user, of a new account option.
